(19) United States
(12) Patent Application Publication
(10) Pub. No.: US 2011/0169950 A1
(43) Pub. Date: Jul. 14, 2011

(54) ARCHITECTURE FOR WIRELESS COMMUNICATION AND MONITORING

(75) Inventor: John V. Weaver, (US)

(73) Assignee: Liberty Imaging LLC

(21) Appl. No.: 13/005,510

(22) Filed: Jan. 12, 2011

Related U.S. Application Data
(60) Provisional application No. 61/294,346, filed on Jan. 12, 2010.

(51) Int. Cl. H04N 7/18

(52) U.S. Cl. 348/143; 348/E07.085

(57) ABSTRACT

An apparatus and a method for wireless communication and remote surveillance are disclosed. According to one embodiment, the apparatus includes a CMOS based high definition video camera with the structure to perform analytics. Furthermore, the same network access point that sends/receives audio-video signals from the video camera also sends/receives wireless broadband Internet data, which can comply with any wireless networking standard, including but not limited to WiMAX, Wi-Fi and LTE.

This application claims priority to U.S. Provisional Application No. 61/294,346, filed on Jan. 12, 2010 which is incorporated herein by reference.

### FIELD

The present invention relates generally to systems, methods and processes for wireless data transfer. More particularly, the present invention relates to architecture for wireless communication and remote surveillance system.

### BACKGROUND

The telecommunications standard known as “Worldwide Interoperability for Microwave Access”, known as “WiMAX” and “Long Term Evolution”, known as “LTE” are synchronous wireless technology. WiMAX and LTE can provide Ultra-Broadband (in excess of 5 Mbits/s) (WiMAX and LTE) Internet service for its users, and eliminates the need to provide wireline Internet services. Future communication standards and improvements to current standards will further increase bandwidth. The elimination of the need for wired Internet service is particularly beneficial in large urban areas where installing the needed fiber optic or other types of high bandwidth cabling is prohibitively expensive. This is particularly true in large urban areas with high concentrations of public housing, educational facilities and small businesses, where the return on investment for wired infrastructure may not be justifiable to commercial Internet service providers (“ISPs”).

Educational, public housing facilities and small businesses often face security issues requiring remote surveillance. The need for remote surveillance is usually performed using one or more remotely located video cameras feeding video and (usually) audio signals to one or more operations center, where any of the video and audio feeds can be viewed and analyzed for any potential problems. Video can be viewed in real time and can also be stored for later viewing. In advanced automated systems where analytics embedded in the camera are capable of triggering additional functions if protocols are breached video and audio plus analytics results can be passed on in real or near-real time to emergency first responders and law enforcement for appropriate action. However, such video has been low quality, generally even less than the analog “standard definition” NTSC or PAL television system, which only provided four hundred eighty vertical lines of interlaced video for NTSC or five hundred and twenty five vertical lines for PAL, in 4:3 aspect ratio.

The cost for deploying such a video surveillance system is high. A coaxial cable wired communication system was used, meaning that expensive cabling was required, cabling that is difficult to maintain, could be subject to wear and tear, obsolescence and vandalism.

Because of the cost and other issues associated with upgrading coaxial cable to broadband capability or installing Optical Cable (fiber) wired Internet access in large urban areas to educational, public housing facilities and small businesses that want such Internet service for students, residents and commerce cannot get it because ISPs either do not want to upgrade existing coax systems or install fiber networks in these geographical areas where these facilities are located or cannot justify the return on investment to supply ultra-bandwidth service. Moreover, even where coaxial cabling is in place that is capable of being upgraded to provide broadband Internet access to educational, housing facilities and small businesses, such cabling is not upgradeable to sufficient bandwidth to carry both ultra-broadband Internet data and surveillance signals because the combined bandwidth required, up and downstream, is larger than coaxial cables can carry. Fiber is capable but cost prohibitive in low ROI sections of large urban areas.

### SUMMARY

An apparatus and a method for wireless communication and remote surveillance are disclosed. According to one embodiment, the apparatus includes a Complementary Metal Oxide Semiconductor (CMOS) based high definition video camera with the structure to perform analytics. Furthermore, the same network access point that sends/receives audio-video signals from the video camera also sends/receives wireless broadband Internet data, which can comply with any wireless networking standard, including but not limited to WiMAX, Wi-Fi and LTE.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

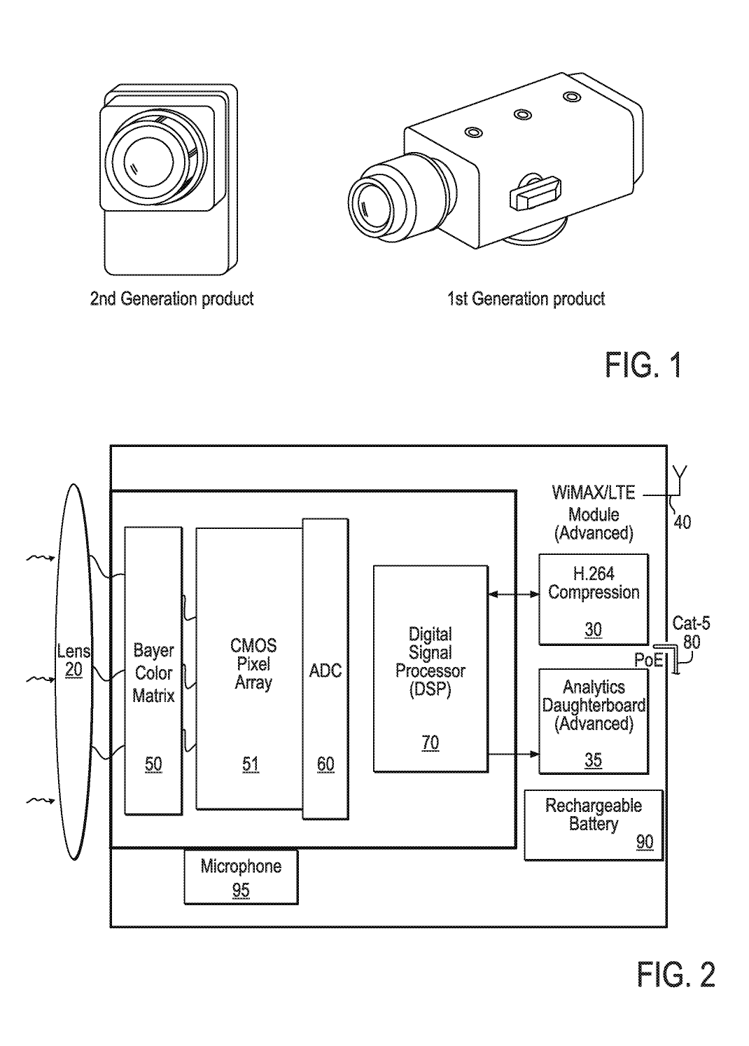

FIG. 1 illustrates the first and second generation of the apparatus.

FIG. 2 illustrates the architecture of a presently preferred apparatus.

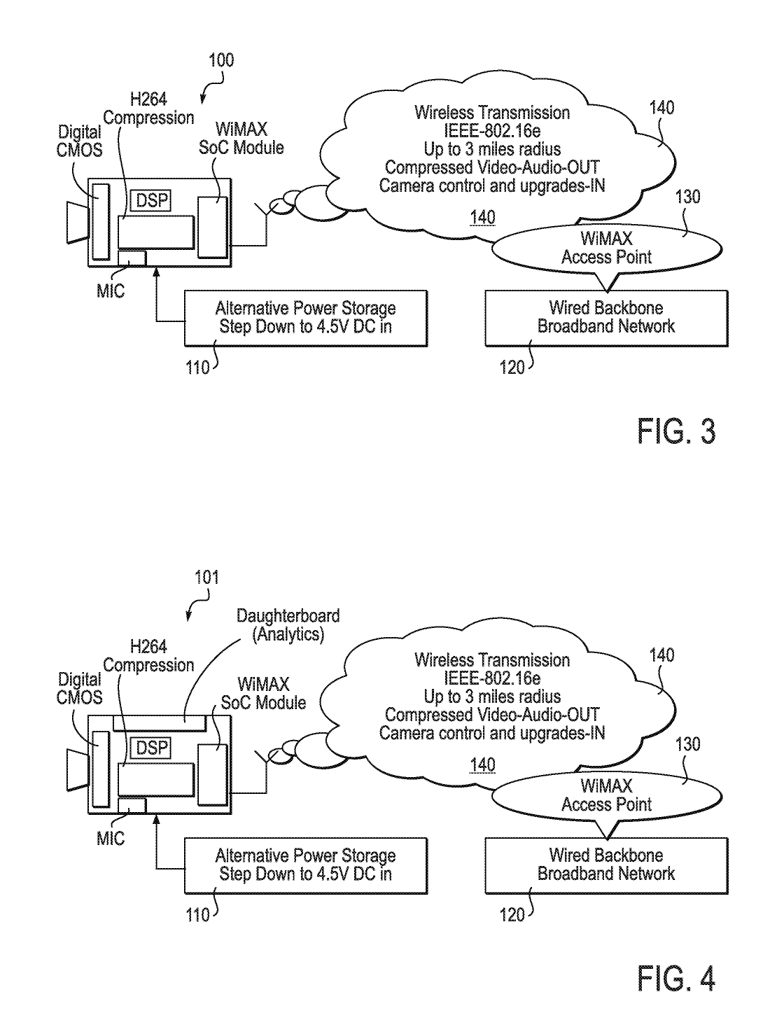

FIG. 3 illustrates a video camera apparatus disposed at a fixed-position remote location for use in a surveillance network.

FIG. 4 illustrates a video camera apparatus disposed at a fixed-position remote location where the apparatus has analytics capability.

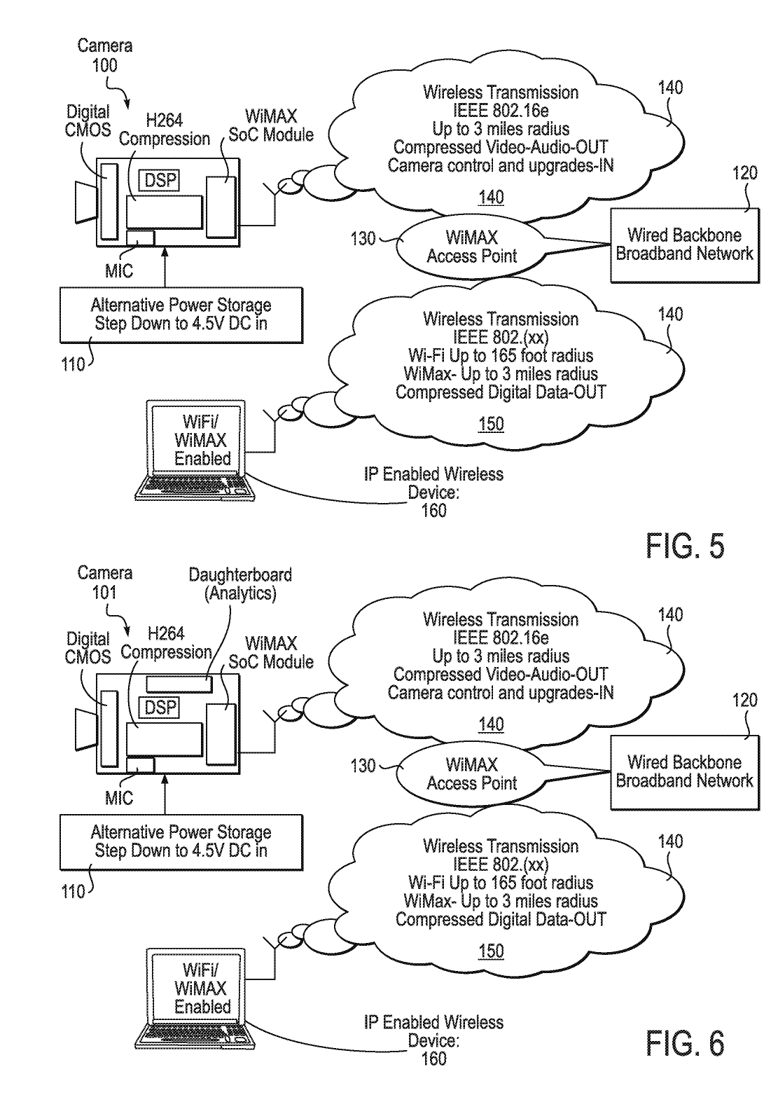

FIG. 5 illustrates a video camera apparatus that is placed at a fixed-position remote location in a surveillance network. The same wireless network can service both a network of video surveillance cameras like those described herein and an Internet protocol (IP) based network for broadband Internet access.

FIG. 6 illustrates a video camera apparatus that is placed at a fixed-position remote location in a surveillance network where the video camera has the necessary structure to perform analytics. The same wireless network services both a network of video surveillance cameras and an Internet protocol (IP) based network for broadband Internet access.

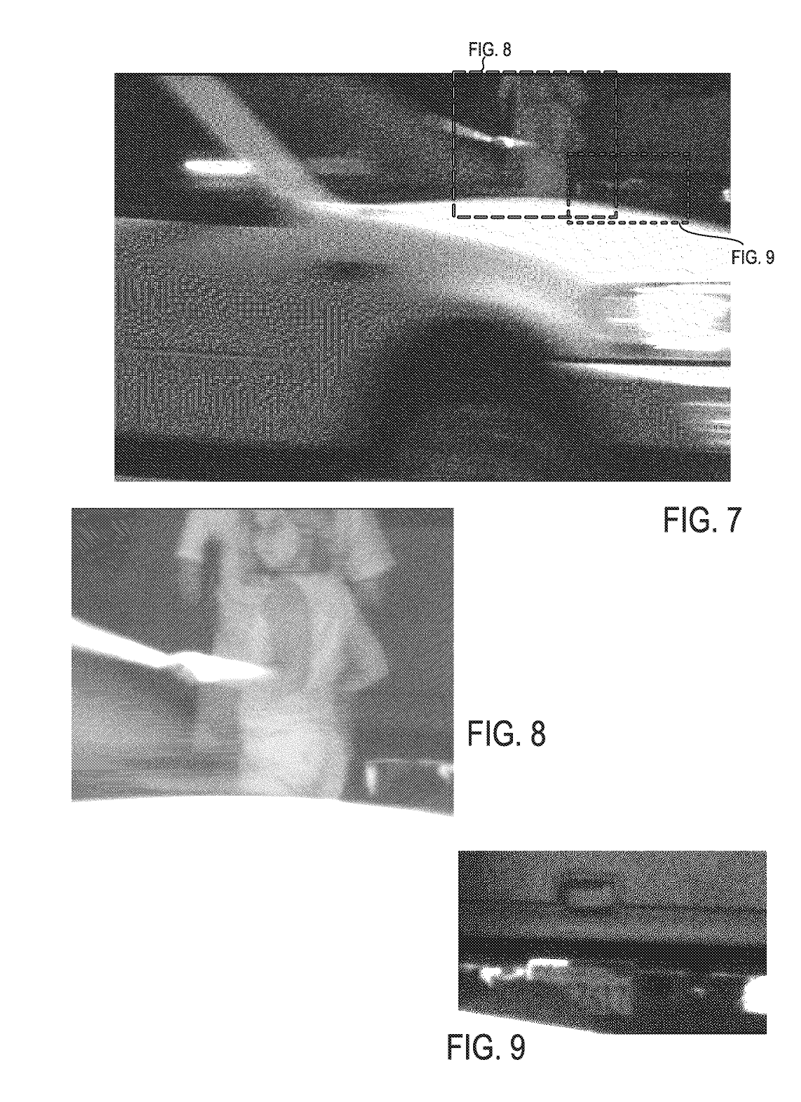

FIG. 7 illustrates one frame of video.

FIG. 8 illustrates one frame of video enhanced by the analytics.

FIG. 9 illustrates the processing to enhance the image to the point where a portion of a license plate can be identified.

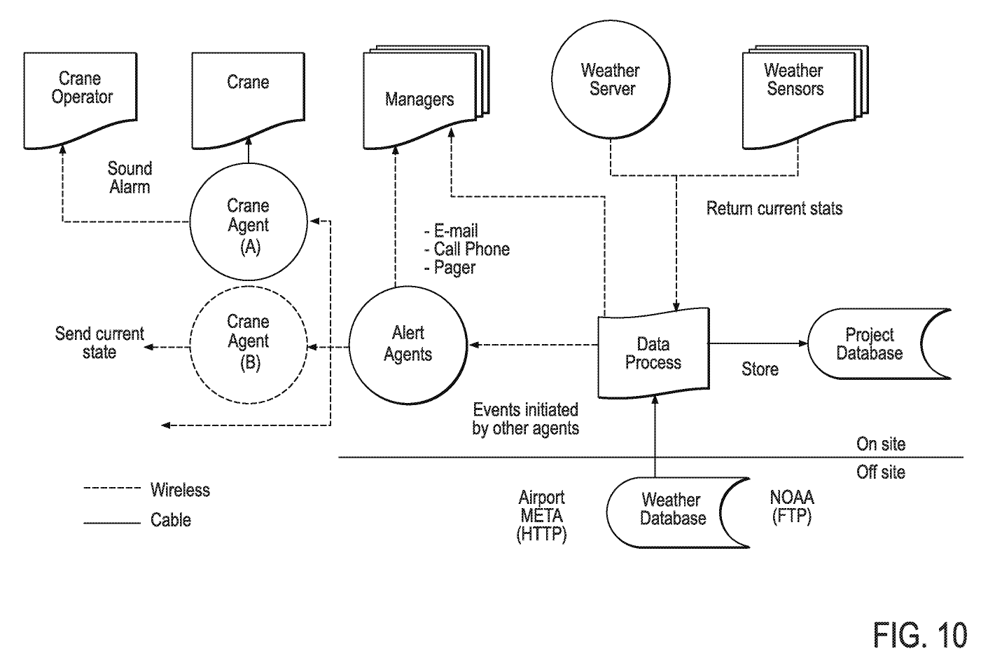

FIG. 10 illustrates wireless communication between different components of an agent based crane alert model.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

An apparatus and a method for wireless communication and remote surveillance are disclosed. According to one embodiment, the apparatus includes a CMOS based high definition video camera with the structure to perform analytics. Furthermore, the same access point that sends/receives audio-video signals from the video camera also sends/receives wireless broadband Internet data, which can comply with any wireless networking standard, including but not limited to WiMAX, Wi-Fi and LTE.

The various embodiments described herein allow for providing Internet access to educational facilities as well as video surveillance. Surveillance can use high definition video, for example video having seven hundred twenty vertical lines of progressively scanned video (“720p”), one thousand eighty vertical lines of progressively scanned video (“1080p”), although digital (DTV) enhanced definition progressive (EDTV) video can be used having 480 vertical lines of progressive scanned video (“480p”), all at a widescreen aspect ratio of 16×9. Microphone audio pickups can also be used.

The same system can be used to provide students and residents wireless ultra-broadband Internet connectivity, which can interpret any wireless standard and currently contemplates using the WiMAX or LTE standard. Regardless of format (cellular, WiMAX, Wi-Fi, LTE etc.), a wireless ultra-broadband system preferably has a common access point for both data from the surveillance equipment (cameras, microphones, etc.) and broadband Internet users to pass through simultaneously.

The camera can output a video format according to the SMPTE, 296M standard, which allows for either high definition 720p widescreen (e.g., 16×9) video or the SMPTE 259M standard, which allows for enhanced definition 480p widescreen format. Future standards, e.g., SMPTE274M, can also be used. The camera can use an embedded wireless module (e.g., a WiMAX/LTE module) to transmit the video along with an audio signal from an embedded microphone wirelessly to a fixed position access point. In certain embodiments, the access point serves the dual purpose of collecting wireless feeds from the cameras used in the surveillance system as well as from personal computers used in the educational, housing facilities or small businesses that are compatible with the wireless standard (e.g., WiMAX/LTE) being used.

The camera is preferably an HDTV capable Complementary Metal-Oxide Semiconductor, Active Pixel, imaging System on Chip (CMOS) single chip digital color camera. The camera can operate on just 3.0 watts of power.

Presently preferred specifications, which can vary according to application, include the following:

### Technology:

DIGITAL CMOS AP ISOC
⅓″ 1280×960 pixel array
Pixel Dynamic Range 120 db
16×9 widescreen display
DSP
Digital HD 720p “1-MegaPixel” 60 fps
Programmable

### Outputs:

Power over Ethernet (PoE), IEEE 802.16e (WiMAX) or LTE
Digital Audio Microphone
IEEE H.264 (option Motion JPEG 2000) Compression
IP Broadband Networking Capable
IPv4 interne protocol, upgradable to IPv6
Video and Snapshot modes

### Color:

Recommendation ITU-R BT 709
Color bar generator

### Power:

5V DC
Power consumption, min 2.5, max 5.0 Watts

### Small Form Factor Embodiment:

Rugged aluminum enclosure (sans lens)
3.75″ (D)×2.5″ (W)×2.0″ (H)
Weight: 10 to 12 oz
Modular design
Operating temp −20 to +70 C

### Processing Library:

Basic Analytics (Daughterboard Optional)
32 GB microSD Card (Optional)
Automatic gain/exposure control
RGB Bayer De-Mosaic interpolation
Auto White and Black balance
Adjustable gamma
Camera ID
Diagnostics

### Applications:

Facilitates prevent-deter analytics, security and surveillance systems
Improved recognition and targeting
High-risk government infrastructure
Unmanned utilities
High-value commercial and residential public space security
Human and veterinary diagnostics/internal surgery
Automated manufacturing
Retail shoplifting enforcement
Monitoring people flow
Automated framing
Video Security as a Service (VSaaS) over Cloud Computing

In one embodiment, the camera will preferably use CMOS image sensing technology instead of CCD (charge-coupled device) technology because CMOS technology has many advantages over CCD technology. CMOS stands for Complementary Metal-Oxide Semiconductor, Active Pixel Imaging System on a Chip. Plain CMOS processors are the architecture of most computer CPUs and memory modules. Image sensors are silicon chips that capture and read light.

CCD sensors rely on specialized fabrication that requires dedicated and costly manufacturing processes. In contrast, CMOS image sensors can be made at standard manufacturing facilities that produce roughly 90% of all semiconductor chips today, from powerful microprocessors to RAM and ROM memory chips. This standardization results in vast economies of scale and leads to ongoing process-line improvements. CMOS processes, moreover, enable very large scale integration (VLSI). This advantage is used by “active-pixel” (AP) architectures to incorporate selected camera functions onto the chip. Such integration creates a compact camera system that is more reliable and reduces the number of peripheral support electronics packaging and assembly, further reducing cost.

Active-pixel architectures consume much less power, up to 100× less power, than their CCD counterparts. CCD systems, on the other hand, tend to be inherently power hungry. This is because CCDs are essentially capacitive devices, needing external control signals and large clock swings (5-15 volts) to achieve acceptable charge transfer efficiencies. CCD off-chip support circuitry dissipates significant power. CCD systems also require numerous power supplies and voltage regulators for operation.

In CMOS active-pixel image sensors, both the photodetector and the readout amplifier are part of each pixel. This allows the integrated charge to be converted into a voltage inside the pixel, which can then be read out over X-Y wires (instead of using a charge domain shift register, as in CCDs). This column and row addressability, similar to common DRAM, allows for window-of-interest readout (windowing), which can be utilized for on-chip electronic pan, tilt, and zoom. Windowing provides much added flexibility in applications that need image compression, motion detection, or target identification and tracking and various recognition security programs.

With active-pixel architectures, the RMS input-referred noise is comparable to the very high-end (and expensive) CCDs. Both technologies provide excellent imagery compared with other CMOS image sensors. Advanced AP architectures use intra-pixel amplification in conjunction with both temporal and fixed-pattern noise suppression circuitry (i.e., correlated double sampling), which has the potential to produce exceptional imagery in terms of dynamic range (a wide ˜75 dB) and noise (a low ˜15 e-RMS noise floor), with low fixed-pattern noise (<0.15% sat). AP active-pixel sensors achieve quantum efficiency (sensitivity) that is comparable to high-end CCDs, but, unlike CCDs, they are not prone to column streaking due to blooming pixels. This is because CCDs rely on charge domain shift registers that can leak charge to adjacent pixels when the CCD register overflows, causing bright lights to “bloom” and leading to unwanted streaks in the image. In some AP architectures, the signal charge is converted to a voltage inside the pixel and read out over the column bus, as in a DRAM. Also AP sensors can have built-in anti-blooming protection in each pixel, so that there is no blooming. And smear, caused by charge transfer in a CCD under illumination, can also be avoided.

CMOS active-pixel (“AP”) designs are inherently fast, which is an advantage in machine-vision and motion-analysis applications particularly. AP designs can drive an image array's column buses at greater speeds than is possible on passive-pixel CMOS sensors or CCDs, while on-chip analog-to-digital conversion (ADC) eases the driving of high-speed signals off-chip. A separate benefit of on-chip ADC is the output signal's low sensitivity to pick-up or crosstalk. This facilitates computer and digital-controller interfacing while adding to system robustness. Additional noise reduction is a further benefit of on-chip ADC as analog degradation is arrested much early in the process.

CMOS active-pixel architectures allow signal processing to be integrated on-chip. In addition to the standard camera functions, AGC (Automatic Gain Control), auto-exposure control, etc., higher-level DSP functions can be realized. Such higher level DSP functions include anti-jitter (image stabilization) for handheld or unstable camera platform situations, color encoding, computer databus interface circuits, multi-resolution imaging, motion tracking for perimeter surveillance (“smart image sensing”), target recognition, compression, internet distribution and wireless camera control.

CMOS architectures feature programmability that permits selected functions to be controlled by the camera operator. This capability provides, for the first time, the opportunity to design a broad array of options that are not possible with CCDs. The ability to program the sensor permits any number of innovations that will expand the product horizontally across several markets such as the internet, homeland security, health care, automated manufacturing, e-commerce conferencing, machine vision, automated farming and defense without having to redesign the BCE (Basic Camera Engine). On chip digital processing leads to a general reduction in size, power consumption, weight, and manufacturing cost.

FIG. 1 shows first generation and second generation of the video camera apparatus. The architecture of a presently preferred video camera apparatus is seen in FIG. 2.

As can be seen in FIG. 2, the apparatus (10) has a lens (20) which focuses light onto imaging sensor (50). CMOS imaging sensor (50) can comprise a CMOS pixel array (51) that may have a Bayer color filter matrix (52) thereon. Signals created by the pixels on the CMOS sensor are converted to digital signals via an analog to digital converter (ADC) (60). There can be either a single ADC (60) having multiplexed inputs or an ADC (60) for each pixel. The ADC (60) outputs digital data to a digital signal processor (DSP) (70) that can perform various functions, e.g. auto gain control (AGC), auto-exposure control, image stabilization, color encoding, computer databus interfacing, multi-resolution imaging, motion tracking for perimeter surveillance, target recognition, compression, internet distribution and wireless camera control. Furthermore, the camera can have a Power over Ethernet module (80) which provides for wired connectivity.

The processed digital video is then compressed using codec's (30) to lighten the data load and also to allow decompression at a base operations center. The compressed video along with any other data, i.e. audio, control, site specific and system data, are then provided to a WiMAX/LTE module (40) for wireless transmission to an access point. In case there is no access to WiMax or LTE, a cellular phone connectivity or Wi-Fi could also be used for wireless transmission.

In addition, the uncompressed data from the DSP can be provided to an analytics board (85), which can have a processor and memory thereon, which can allow for site specific data analysis, as will be discussed below. Moreover, the apparatus can include a rechargeable battery (90) and a microphone (95).

FIG. 3 shows a video camera (100) disposed at a remote location for use in a surveillance network. Similarly, FIG. 4 shows a video camera (101) disposed at a remote location where the video camera (101) has analytics capability.

In FIGS. 3 and 4, it can be seen that the video camera (100 and 101) includes a WiMAX module that can transmit compressed video-audio signals (140) as WiMAX signals (e.g., IEEE 802.16e) to a WiMAX access point (130), which converts the wireless signal to an appropriately encoded signal for a wired backbone of a broadband network (120) (e.g., encoded for carriage on copper wires using digital subscriber lines (DSL), coaxial cable or modulated to an optical signal for carriage on optical fiber). Moreover, in FIGS. 3 and 4, video camera 100 and video camera 101 can use an alternative power storage source (110). FIG. 4 further shows a video camera (101) having analytics, which will be discussed below.

In another embodiment, the same wireless network can service both a network of video surveillance cameras like those described herein and an Internet protocol (IP) based network for broadband Internet access. This can be seen in FIGS. 5 and 6.

As seen in FIGS. 5 and 6, a video camera like that described herein (100 and 101) is placed at a remote location in a surveillance network. FIG. 6 shows a video camera (101) that has the necessary structures to perform analytics. In both FIG. 5 and FIG. 6, the same access point (130) that sends/receives compressed audio-video signals (140) from the video camera (101) also sends/receives wireless broadband Internet data (150) from IP enabled devices (160), which can comply with any wireless networking standard, including but not limited to WiMAX, Wi-Fi and LTE. In FIGS. 5 and 6, WiMAX access point (130) converts the wireless signal to an appropriately encoded signal for a wired backbone of a broadband network (120) (e.g., encoded for carriage on copper wires using digital subscriber lines (DSL), coaxial cable or modulated to an optical signal for carriage on optical fiber). Moreover, video camera 100 in FIG. 5 and video camera 101 in FIG. 6 can use an alternative power storage source (110).

As discussed above, it is possible to equip the video cameras with structures that can provide for analytics capabilities. Examples of such analytics include the ability to perform calculations that can determine certain characteristics of the subject under surveillance by the camera. For example, it could be determined that the subject is large or small. The analytics could also determine whether the subject is a human being or an animal. The analytics could be programmed to determine whether it has detected motion, and if so, send a specific alarm signal to the command and control operations center.

In addition, the analytics could be used to search for predetermined forms. For example, the system could watch for structures that match the form of typical firearms, and send alarm signals to the command and control operations center should such a form be calculated. Moreover, because the video camera will be able to communicate, in real time, through a wireless gateway to a command and control operations center, the video signals could be provided in real time to other agencies, for example the Department of Homeland Security, where the data could further analyzed by more advanced software. Similarly, data from external third party databases for example, the Federal Burial of Investigation, could be sent to the video camera, where analytics or other hardware could match persons under surveillance with images in these third party databases.

Enhancement analytics could be used to enhance video using video enhancement techniques that could allow further clarification of critical information. For example, analytics could be used to enhance video of a license plate, thereby allowing for real time identification of suspicious vehicles. Similarly, when undergoing real time monitoring, an operator at a command and control operations center could control the camera to zoom in to a specific area of interest under surveillance. In certain embodiments where the sensor has adequate resolution, such zooming could be accomplished electronically, without using zoom lenses (that are larger and more expensive).

For example, FIG. 7 shows a frame of video.

If an operator at a command and control operations center is concerned about the person in the upper portion of the frame, analytics allow enhancement of the frame of video data, which is seen in FIG. 8.

While the enhanced image may not be ideal, it provides enough information for a potential identification. Moreover, other analytics could be used for other portions of this frame of video. For example, in the lower right hand corner, a person at the command and control operations center might think this is worth further processing. Here, the processing enhanced the image to the point where a portion of a license plate could be identified, as seen in FIG. 9.

The analytics capabilities of the system can be used to provide many different features, many of which require data mining for extracting patterns from data and comparing them to known examples to identify any subject, target or area of interest. The camera described herein has a flexible design that allows digital analytics at the nodes of a broadband wireless video/audio network.

A first embodiment of a camera with analytics capabilities is a fixed position (“FP”) camera where the camera is preferably mounted on a stationary structure with Access Points in general proximity interfacing with a backbone internet supplier. A second embodiment of a camera with analytics capabilities is a mobile (“M”) camera where the camera can be moved from place to place with a broad area network system of access points connected to the internet backbone. A third embodiment utilizes Power over Ethernet (PoE), which provides for a wired (e.g., using copper twisted pair cabling, coaxial cable or optical fiber cabling) camera that can be used where the infrastructure exits or contemplated and will include the Analytics feature.

At least four benefits can be derived from such embodiments. First, existing wireless (Wi-Fi) does not always provide sufficient bandwidth (up to 3.1 Mbits/s) to transmit the data files modern analytics programs are capable of producing or sufficient information to be effective. Second, superior image quality, which is the main benefit of HDTV formats, are diminished by heavy compression required for transmission over Wi-Fi networks. Third, Wi-Fi technology is restricted to a range of approximately 300 feet. This is a major inhibitor to innovative and highly desirable broadband applications. WiMAX has at least a three mile transmission range and provides 100 MBits or more bandwidth. LTE will extend the wireless reach of the signal and broaden the bandwidth as technology provides and markets demand. Finally, the addition of a WiMAX/LTE and Analytics extends the concept to developing a camera that offers the flexibility to be utilized across a number of distinct industries.

Advanced digital signal processors (DSP) incorporate many of the functions previously managed by separate specialized computer chips like compression, bin-sampling to reformat the picture as well as two way communications to govern basic camera functions and remote lens operation. Advance Complementary Metal Oxide Semiconductor (CMOS), Active Pixel (AP) imaging System on a Chip (iSoC) introduced Analog to Digital (AD) conversion at the sensor level facilitating on chip processing that minimizes artifacts and improves image quality. As a result we now have the ability to design and build commercially affordable cameras that are Programmable providing broad flexibility to implement a broad array of in-camera originated Analytics.

To realize this potential the presently preferred camera incorporates as an integral part of the camera design a supplemental digital memory and a daughterboard for analyzing digital video/audio data channeled from the camera for site specific applications. Previously, analyzing video/audio data required transmitting the digital data file to a distant location for computer processing and then distributing the results. The present camera allows such functions to be performed in-camera at the outer edge of the system where the information originates and transmitting the Analytics results via the Internet directly to responsible authorities for evaluation or action. Performing analytics at the edge of the system can provide actionable information on a real or near real time bases for site specific decision making. This provides a reduction in lag time between original capture and delivery of meaningful information to command and control operations center for evaluation and action, reduction in infrastructure cost and construction time, and, a platform to implement site specific “programmable” Analytics that can be modified by field personal.

By distributing the analytics to the cameras and away from a centralized location, a programmable processor can be used in the camera, allowing modifications on a site-by-site basis. As just one example, a particular camera can have analytics software and/or hardware modified to condition captured video color to match special requirements for facial recognition. Thus, the camera can be tailored to meet a wide variety of cross industry applications in science, education, industry, and law enforcement.

Distributed analytics allows for improved prevention and deterrence of criminal activity. For example, a fixed position camera is suitable for specific sites like banks where specialized recognition software can identify typical weapons, demand notes, wardrobe, masks and a limited image file of “active” bank robbers can be downloaded into cameras. Such fixed position cameras can have software, data and/or hardware modifications to include information about potential bank robbers in that city, neighborhood or even the specific branches. For example, when the bank or police have a tip about an eminent robbery attempt, data concerning a suspect can be used by the cameras. For example, data like ‘last seen warring a red cap and yellow jacket’ could be downloaded as soon as the information is known to the cameras in the suspected banks. Once the suspect is identified alarms and other prevention tactics could be deployed instantly. Notice could then be sent to the police who could then be in real time observance of the event. Because the analyses is locally computed and the results transmitted directly to authorities over the internet using security coded IP addresses, this data can be sorted and sent to the relevant control center for evaluation and further action. Nearly all of the lag time is removed from the system by circumventing the need for extensive wired networks resulting in notifications in real or near real time.

In addition to video, sound identification is becoming a critical component of security strategies. Presently, sound information is collected and processed separately from video. The present camera incorporates a microphone (either digital or analog) that can be integrated into the analytics system. Critical detection of sounds that signal an emergency like fire alarms, gun shots, calls for help, explosions, etc. can be detected locally and transmitted to the appropriate authorities in real or near real time. This very early detection is critical to improving prevention and response times. Video and Audio analytics can also be coordinated for optimum results.

Note that such a distributed analytics system can also be used for applications other than security. For example, safety inspections and identification of a variety of maintenance issues from light bulbs to stuck elevators are possible.

Embodiments of the camera can be used in retail environments. IP Network video systems can significantly reduce loss due to theft, improve staff security and optimize store management. A distributed camera/analytics system enables remote and local monitoring of stores at any time and from any place, and offers the shortest return on investment. Analytics is coming on line by combining video surveillance with customer counting, integrated alarm functionality and monitoring of electronic cash registers. EDTV 480p, HD 720p and 1080p in stores will only amplify these benefits.

Embodiments of the camera can be used in transportation environments. Remote surveillance options enable any authorized security staff to cover everything from check-in areas of airports, train stations, platforms, gates, hangars, depots, parking lots and baggage systems. Analytics in conjunction with higher quality images of HD improves prevention surveillance techniques. Traffic information can also be monitored to reduce congestion and improve efficiency. WiMAX/LTE adds tremendous flexibility and lower cost infrastructure for transportation planners.

Embodiments of the camera can be used in educational environments. From day-care centers to universities, video analytics will improve deterrence of vandalism and increase the safety of staff and students. Where infrastructure cost is critical upgrading to a WiMAX/LTE system may provide an affordable pathway to a superior solution, since as discussed above, the need for most if not all expensive wiring is eliminated. Analytics will provide critical warnings like motion detection that can generate alarms and give security operators accurate, real-time images on which to base decisions.

Embodiments of the camera can be used for city surveillance. Security rings comprised of IP Networked cameras is one of the most useful tools for fighting crime and protecting citizens, acting both to detect and deter. In emergencies, network cameras can help police or fire-fighters pinpoint where their assistance is most needed.

Embodiments of the camera can also be used for governmental applications. Governmental assets like public buildings, museums, offices, libraries and prisons require reliable 24/7 security at entrances and exits to record who comes in and out. A distributed camera system with analytics can perform several valuable tasks, such as preventing terrorist penetration and collecting statistical data on visitors.

Embodiments of the camera can be used in banking and finance applications. WiMAX/LTE, HD and advanced analytics are expected to greatly improve state-of-the-art surveillance systems that can monitor any number of branch offices from a central location, as well as visually verify alarms to security staff and law enforcement.

Embodiments of the camera can be used for automated-precision farming. GPS guidance, CPU/software, pneumatic actuators and sensors have facilitated unmanned tractors, fruit pickers, crop control and autonomous harvesters. These are a few of the innovations that have motivated quick adoption of technology in agriculture. The automated version of farming has been dubbed “Precision Agriculture” by MIT's Computer Science and Artificial Intelligence Laboratory (CSAIL) although the industry prefers “Precision Farming” which is a more inclusive term.

Use of a camera having analytics as described herein with precision farming techniques can further increase agricultural productivity. This is especially true if combined with a tractor based Global Positioning System (GPS). In addition to guiding tractors, embodiments of the camera described herein provide additional functionality. For example, a camera with analytics can provide for navigation, increasing farming continuity while maintaining accuracy and providing soil conditions from remote locations.

A camera having analytics as described herein can also be used for healthcare applications. Use of a camera with analytics in a hospital provides a flexible system for cost-effective, high-quality patient monitoring providing authorized hospital staff a live patient view from multiple locations, activity detection, and allows for providing remote assistance. Analytics can provide an extensive menu of specialized programs to assist in treatment.

A camera having analytics as described herein can also be used for medical applications. High resolution imaging is enjoying very rapid acceptance among medical research and development products designers. Those applications that employ full motion video are eager to upgrade to HDTV resolution, especially the tenfold improvement in color selection (palate) that SMPTE standards provide. For example, MegaPixel formats are essential for research and some diagnostic specialties plus infra red, X-ray and ultrasound imaging. There remains a very large segment of the industry that will innovative applications that take advantage of interoperable standards like SMPTE and IEEE offer and analytics at the edge of a network can then be transmitted to specialist for evaluation in real or near real time. Exemplary applications include video assisted automated surgery including remote surgery, distant care for geriatrics, remote diagnoses for dermatology, remote patent recovery monitoring and veterinary diagnostics.

Another embodiment of the camera with analytics includes Emergency Medical Services. The United States Defense Department has developed a new medical field, “Battlefield Triage”. A number of techniques, including video/audio to assist trained medics in applying life saving therapy to critically wounded worriers to improve their survival rate during transport to field hospitals have been perfected. At that stage of treatment, more satisfactory satellite HD systems are employed to involve additional medical specialist to assist in developing a treatment protocol to further improve survival rates. This procedure has proven to be so successful that death rates from battle wounds have been improved by an estimated 60%. While such systems are very effective, they have very high cost and are very complex. An embodiment of the camera with analytics described herein can be used for such commercial applications. Such embodiments require progressive scan digital images, accurate color rendition and sufficient wireless range to reach the emergency trauma team at the hospital the EMS truck is assigned too. Analytics to support accurate evaluation, diagnoses and vital sign detection plus innovations to asset EMS personal in applying critical therapy are contemplated.

An embodiment of the camera with analytics useful for such emergency medical services is mobile, and can include a camera with a quality image of at least one megapixel (720p). Progressive formats like those used in this embodiment are rapidly becoming a requirement for advanced medical applications to improve image quality and avoid systemic artifacts associated with interlace. Such an embodiment can provide at least a tenfold improvement in color rendition. Improved color rendition can provide benefits for initial evaluation of emergency patients. Examples are: skin tone, observable obstructions, external lacerations, expression, verbal communication, blood color and infections. Because WiMAX has a range of up to three (3) miles, a network using the present concepts can be a video triage system within existing hospital infrastructures based on universal standards that can be interoperable with other medical specialist for consultation and with national data bases for up to date information. With the incorporation of LTE the radius of coverage of such a system will be extended.

With such an interoperable system hospital staff can exchange critical data in real time with in-depth resource agencies outside the hospitals infrastructure.

A distributed camera system having analytics is also useful for garment manufacturing and fashion. The fashion industry is in the grips of the GPS revolution and web-based customization accessible from anywhere in the world. HD is in the system today analytics at the edge of the network is not prevalent. In one embodiment, a camera based system using analytics can be used for quality control during manufacturing.

A camera with analytics can be integrated into an automated warehousing system such as an Automatic Storage and Retrieval Robotic Systems (AS/RS). Solutions are tailored for industry purposes such as production storage, Work-In-Process Inventory (WIP) warehouse, cold or deep-freeze storage and distribution centers. The general benefits of AS/RS include maximizing use of storage space, scalability, productivity gains and minimizing stock on hand. All of these factors have contributed to the wide acceptance of “just in time manufacturing” which continues to have a profound effect on productivity gains.

However, automated warehousing use intelligent machines to take over the warehousing function for physical products. As machines become more intelligent additional productivity gains will be realized and the practice will expand through innovation. Several embodiments for a distributed wireless camera having analytics are described. In a first embodiment, job specific direction can be provided when upgrading and retrofitting antiquated installations with minimal or no-shutdown time. In another embodiment, cameras can be relocated or repositioned as job functions change. Such repositioning can be done remotely, based on analytics.

A distributed wireless camera network with analytics can also be used in an automated (e.g., robotic) manufacturing facility. Robotic manufacturing facilities enable manufacturers to automate plants with a variable production mix. Multiple engineering disciplines use a software based virtual environment to plan and validate manufacturing systems that range from single units to complete production lines. The availability of a wireless camera having analytics introduces the prospect of finer grain accuracy, flexible mobility to change camera locations and job orders on the fly.

A distributed wireless camera network with analytics can also be used in construction and natural resource extraction. Unmanned construction, mining and drilling is work performed by remotely operated construction machinery that corresponds to an operator controlled robot. A collaborative multi-agent system for real-time monitoring and planning construction systems could use the wireless camera with analytics network as described herein. By using agents, wireless communication and field data capturing technologies an up-to-date 3D software model of the construction site is created. Real time data is processed by the multi-agent system to detect any possible collisions or other conflicts related to the operations of the equipment, and to generate a new plan in real time. The potential advantages of the proposed approach are: more awareness of dynamic construction site conditions, a safer and more efficient work site, and a more reliable decision support based on good communications.

Further wireless communication technologies are needed for agents to communicate with each other on site. Ultra-broadband WiMAX/LTE networks would solve many of the communication problems caused by the “islands of information” in construction. As an example, in FIG. 10, the dotted lines show wireless communication between different components of an agent based crane alert model.

By the addition of a Security System that included analytics, much greater control of the operation can be developed.

Other embodiments allow the use of the distributed wireless camera system with analytics for national defense applications. The United States Department of Defense has accepted 720p as a HD system format to be used to develop battlefield applications. There are any numbers of manned and unmanned machines that can gain greater capability in completing there mission by the availability of a WiMAX/LTE capable camera. Analytics at the edge will refine and expand the current mission objectives.

What is claimed is:

1. A wireless data communication apparatus comprising:
a high definition surveillance camera for monitoring a particular area of interest and capturing image data, the surveillance camera comprising an analog to digital converter module to convert analog image data into digital, a processor that processes the digital image data into processed image data, a compression module that compresses the processed data, and a wireless network module that wirelessly receives and transmits the compressed processed data to an access point; and
a wireless access point that receives data from the wireless network module, the wireless access point further transmitting and receiving data that can be carried on the Internet, thereby allowing surveillance Internet service within the geographical area served by the wireless access point.

2. The apparatus of claim 1 further comprising a microphone to capture sound data.

3. The apparatus of claim 2 wherein the processor is a digital signal processor.

4. The apparatus of claim 3, further comprising an analytics module that evaluates the processed image data to find predetermined characteristics of the area undergoing surveillance.

5. The apparatus of claim 4 wherein the analytics module comprises a programmable processor and a memory module.

6. The apparatus of claim 1 further comprising a rechargeable battery.

7. The apparatus of claim 1 further comprising a Power over Ethernet (PoE) module.

8. The apparatus of claim 1 wherein the wireless network module conforms to the WiMAX standard.

9. The apparatus of claim 1 wherein the wireless network module conforms to the LTE standard.

10. The apparatus of claim 1 wherein the wireless network module conforms to the Wi-Fi standard.
